(19) United States
(12) Patent Application Publication
(10) Pub. No.: US 2026/0223195 A1
(43) Pub. Date: Jul. 30, 2026

(54) METHOD FOR WIRELESS COMMUNICATION, TERMINAL DEVICE, AND NETWORK DEVICE

(71) Applicant: GUANGDONG OPPO MOBILE TELECOMMUNICATIONS CORP., LTD., Dongguan (CN)

(72) Inventor: Hao LIN, Dongguan (CN)

(21) Appl. No.: 19/575,212

(22) Filed: Mar. 23, 2026

Related U.S. Application Data
(63) Continuation of application No. PCT/CN2023/121037, filed on Sep. 25, 2023.

(51) Int. Cl. H04W 74/0833; H04L 47/283

(52) U.S. Cl. CPC H04W 74/0833; H04L 47/283

(57) ABSTRACT

Provided are a method for wireless communication, a terminal device, and a network device. The method includes: a terminal device executes a first operation on the basis of first information, the first information being associated with an activation period/an inactive period of a first cell, and the first operation being associated with random access to the first cell.

### CROSS-REFERENCE TO RELATED APPLICATION

This is a continuation application of International Patent Application No. PCT/CN2023/121037, filed on September 25, 2023, the content of which is hereby incorporated by reference in its entirety.

### BACKGROUND

Beam hopping technology is supported in some communication systems, such as a satellite communication system. The introduction of the beam hopping technology has an impact on a random access process of a terminal device, but the related technologies do not consider such impact, which may increase the probability of failure of the random access process.

### SUMMARY

The present disclosure relates to the technical field of communications, and in particular to a method for wireless communication, a terminal device, and a network device. Various aspects of the present disclosure are described in detail below.

In a first aspect, there is provided a method for wireless communication. The method includes that: a terminal device performs a first operation based on first information. Herein, the first operation is associated with random access of a first cell; and the first information has one or more of the following associations: an association with an active period/non-active period of the first cell; and, an association with an activation status/deactivation status of one or more beams within the first cell.

In a second aspect, there is provided a terminal device. The terminal device includes a memory and a processor. The memory is configured to store a program. The processor is configured to call and run the program in the memory to: perform a first operation based on first information. Herein, the first operation is associated with random access of a first cell; and the first information has one or more of the following associations: an association with an active period/non-active period of the first cell; and, an association with an activation status/deactivation status of one or more beams within the first cell.

In a third aspect, there is provided a network device. The network device includes a memory, a processor and a transceiver. The memory is configured to store a program. The processor is configured to call and run the program in the memory and control the transceiver to: transmit first information. Herein, the first information has one or more of the following associations: an association with an active period/non-active period of a first cell; and, an association with an activation status/deactivation status of one or more beams within the first cell.

Considering the active/non-active related information of the cell when performing the random access related operations is helpful to improve the probability of successful random access.

### BRIEF DESCRIPTION OF THE DRAWINGS

FIG. 1A is an example diagram of a communication scenario to which an embodiment of the present disclosure is applicable.

FIG. 1B is an example diagram of another communication scenario to which an embodiment of the present disclosure is applicable.

FIG. 1C is an example diagram of yet another communication scenario to which an embodiment of the present disclosure is applicable.

FIG. 2 is an example diagram of an implementation process of a beam hopping technology.

FIG. 3 is a schematic flowchart of a method for wireless communication according to an embodiment of the present disclosure.

FIG. 4 is a schematic diagram of a pattern of an active period/non-active period of a cell according to an embodiment of the present disclosure.

FIG. 5 is a schematic flowchart of a method for wireless communication according to another embodiment of the present disclosure.

FIG. 6A is an example diagram of one possible implementation of the method shown in FIG. 3.

FIG. 6B is an example diagram of another possible implementation of the method shown in FIG. 3.

FIG. 7A is an example diagram of yet another possible implementation of the method shown in FIG. 3.

FIG. 7B is an example diagram of yet another possible implementation of the method shown in FIG. 3.

FIG. 8 is an example diagram of yet another possible implementation of the method shown in FIG. 3.

FIG. 9 is an example diagram of yet another possible implementation of the method shown in FIG. 3.

FIG. 10 is an example diagram of yet another possible implementation of the method shown in FIG. 3.

FIG. 11 is an example diagram of yet another possible implementation of the method shown in FIG. 3.

FIG. 12 is a schematic structural diagram of a terminal device according to an embodiment of the present disclosure.

FIG. 13 is a schematic structural diagram of a network device according to an embodiment of the present disclosure.

FIG. 14 is a schematic structural diagram of a device to which an embodiment of the present disclosure is applicable.

### DETAILED DESCRIPTION

### Communication system architecture

The technical solutions of the embodiments of the present disclosure can be applied to various communication systems, such as a global system of mobile communication (GSM) system, a code division multiple access (CDMA) system, and a wideband code division multiple access (WCDMA) system, a general packet radio service (GPRS) system, a long term evolution (LTE) system, an advanced long term evolution (LTE-A) system, a new radio (NR) system, an evolution system of the NR system, a LTE-based access to unlicensed spectrum (LTE-U) system, a NR-based access to unlicensed spectrum (NR-U) system, a non-terrestrial network (NTN) system, a universal mobile telecommunication system (UMTS), a wireless local area network (WLAN) system, a wireless fidelity (WiFi) system, a Fifth-generation (5G) system or other communication systems, for example, a future communication system, such as a sixth-generation mobile communication system, a satellite communication systems, etc.

Typically, conventional communication systems support a limited number of connections and are relatively easy to be implemented. However, with the development of communication technology, the mobile communication system will support not only conventional communication, but also, for example, device-to-device (D2D) communication, machine-to-machine (M2M) communication, machine type communication (MTC), vehicle-to-vehicle (V2V) communication, or vehicle-to-everything (V2X) communication, and the like. The embodiments of the present disclosure can also be applied to such communication systems.

The communication system in the embodiments of the present disclosure can be applied to a carrier aggregation (CA) scenario, a dual connectivity (DC) scenario, or a standalone (SA) network deployment scenario.

The communication system in the embodiments of the present disclosure may be applied to an unlicensed spectrum, and the unlicensed spectrum may also be regarded as a shared spectrum. Alternatively, the communication system in the embodiments of the present disclosure may also be applied to a licensed spectrum, and the licensed spectrum may also be regarded as a dedicated spectrum.

The embodiments of the present disclosure may be applied to an NTN system or a terrestrial network (TN) system. By way of example and not limitation, the NTN system includes an NR-based NTN system and an IoT-based NTN system.

The embodiments of the present disclosure describe various embodiments in conjunction with a network device and a terminal device. Herein, the terminal device may also be referred to as a user equipment (UE), an access terminal, a user unit, a user station, a mobile station (MS), a mobile terminal (MT), a remote station, a remote terminal, a mobile device, a user terminal, a terminal, a wireless communication device, a user agent or a user device, and the like.

In an embodiment of the present disclosure, the terminal device may be a STATION (ST) in a WLAN, a cellular phone, a cordless phone, a session initiation protocol (SIP) phone, a wireless local loop (WLL) station, a personal digital assistant (PDA) device, a handheld device having a wireless communication function, a computing device or other processing device connected to a wireless modem, a vehicle-mounted device, a wearable device, a terminal device in a next generation communication system such as an NR network, or a future evolved public land mobile network (PLMN) network.

In an embodiment of the present disclosure, the terminal device may refer to a device that provides voice and/or data connectivity to a user, and may be used to enable connection between people, objects, and machines, for example, a handheld device having a wireless connection function, a vehicle-mounted device, or the like. The terminal device in the embodiments of the present disclosure may be a telephone (mobile phone), a tablet (Pad), a notebook computer, a handheld computer, a mobile internet device (MID), a wearable device, a virtual reality (VR) device, an augmented reality (AR) device, a wireless terminal in industrial control, a wireless terminal in self driving, a wireless terminal in remote medical surgery, a wireless terminal in smart grid, a wireless terminal in transportation safety, a wireless terminal in smart city, a wireless terminal in smart home, or the like. Optionally, the terminal device may be used to act as a base station. For example, the terminal device may act as a scheduling entity that provides sidelink signals between the terminal devices in V2X or D2D, etc. For example, cellular phones and vehicles may communicate with each other via the sidelink signals. Communication between the cellular phone and smart home devices may be performed without relaying the communication signals by the base station.

In an embodiment of the present disclosure, the terminal device may be deployed on land, including indoor or outdoor, handheld, wearable, or vehicle-mounted. The terminal device may also be deployed on the water (e.g., ships, etc.). The terminal device may also be deployed in the air (e.g., on aircraft, balloons and satellites, etc.).

In an embodiment of the present disclosure, the terminal device may be a mobile phone, a tablet (pad), a computer with a wireless transceiving function, a virtual reality (VR) terminal device, an augmented reality (AR) terminal device, a wireless terminal device in industrial control, a wireless terminal device in self driving, a wireless terminal device in remote medical, a wireless terminal device in smart grid, a wireless terminal device in transportation safety, a wireless terminal device in smart city, a wireless terminal device in smart home, or the like. The terminal device according to the embodiments of the present disclosure may also be referred to as a terminal, a user equipment (UE), an access terminal device, a vehicle-mounted terminal, an industrial control terminal, a UE unit, a UE station, a mobile station, a mobile site, a remote station, a remote terminal device, a mobile device, a UE, a wireless communication device, a UE agent, a UE apparatus, or the like. The terminal device may also be stationary or mobile.

As an example and not limitation, in the embodiments of the present disclosure, the terminal device may also be a wearable device. The wearable device may also be referred to as a wearable smart device, which is a generic name of the wearable devices that are intelligently designed and developed by applying wearable technologies to daily wear, such as glasses, gloves, watches, clothing and shoes. The wearable device is a portable device that is worn directly on the body or integrated into the clothes or accessories of the user. The wearable device may be not only a kind of hardware device, but also realize powerful functions through software support, data interaction and cloud interaction. Generalized wearable smart devices have features of full functions and large size, and may realize complete or partial functions without relying on smart phones, such as a smart watch or smart glasses, as well as those only focus on a certain type of application functions and need to be used in cooperation with other devices (e.g., smart phones), such as various smart bracelets and smart jewelleries for physical sign monitoring.

The network device in the embodiments of the present disclosure may be a device for communicating with the terminal device(s). The network device may also be referred to as an access network device or a wireless access network device, for example, the network device may be a base station. The network device in the embodiments of the present disclosure may refer to a radio access network (RAN) node (or device) that connects the terminal device to the wireless network. The base station may generally encompass various names listed below or be interchangeable with the following terms: a NodeB, an evolved NodeB (eNB), a next generation NodeB (gNB), a relay station, an access point, a transmitting and receiving point (TRP), a transmitting point (TP), a master node station (MeNB), a secondary station (SeNB), a multi-standard radio (MSR) node, a home base station, a network controller, an access point (AP), a transmission node, a transceiver node, a base band unit (BBU), a remote radio unit (RRU), an active antenna unit (AAU), a remote radio head (RRH), a central unit (CU), a distributed unit (DU), a positioning node, and the like. The base station may be a macro base station, a micro base station, a relay node, a donor node, etc., or a combination thereof. The base station may also refer to a communication module, a modem, or a chip for being disposed within the aforementioned device or apparatus. Additionally, the base station may be a mobile switching center, a device that assumes a base station function in device-to-device D2D, a vehicle-to-everything (V2X), a machine-to-machine (M2M) communication, a network-side device in a 6G network, a device that assumes a base station function in a future communication system, or the like. The base stations may support networks of the same or different access technologies. The embodiments of the present disclosure do not limit the specific technology and the specific device form adopted by the network device.

The base station may be fixed or mobile. For example, a helicopter or drone may be configured to act as a mobile base station, and one or more cells may move according to the location of the mobile base station. In other examples, the helicopter or drone may be configured to serve as a device communicating with another base station.

In some deployments, in the embodiments of the present disclosure, the network device may refer to a CU or a DU, or the network device may include the CU and the DU. The gNB may also include an AAU.

The network device and the terminal device may be deployed on land, including indoor or outdoor, handheld or vehicle-mounted. The network device and the terminal device may also be deployed on the water. The network device and the terminal device may also be deployed on aircraft, balloons and satellites in the air. The scenario in which the network device and the terminal device are located is not limited in the embodiments of the present disclosure.

As an example and not limitation, in the embodiments of the present disclosure, the network device may have mobile characteristics, for example, the network device may be a mobile device. In some embodiments of the present disclosure, the network device may be a satellite or a balloon station. For example, the satellite may be a low earth orbit (LEO) satellite, a medium earth orbit (MEO) satellite, a geostationary earth orbit (GEO) satellite, a high elliptical orbit (HEO) satellite, or the like. In some embodiments of the present disclosure, the network device may be a base station provided on a land, a water area, or the like.

In the embodiments of the present disclosure, the network device may provide service(s) for a cell, and the terminal device may communicate with the network device through a transmission resource (e.g., frequency-domain resource or spectrum resource) used by the cell. The cell may be the cell corresponding to the network device (e.g., a base station), and the cell may belong to a macro base station or a base station corresponding to a small cell. The small cell herein may include: a metro cell, a micro cell, a pico cell, a femto cell, etc. Such small cells have the characteristics of small coverage range and low transmission power, and are suitable for providing high-rate data transmission service(s).

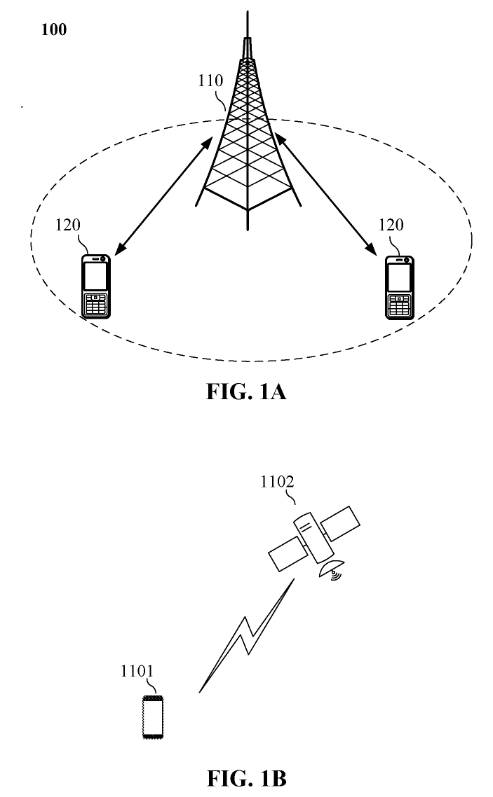

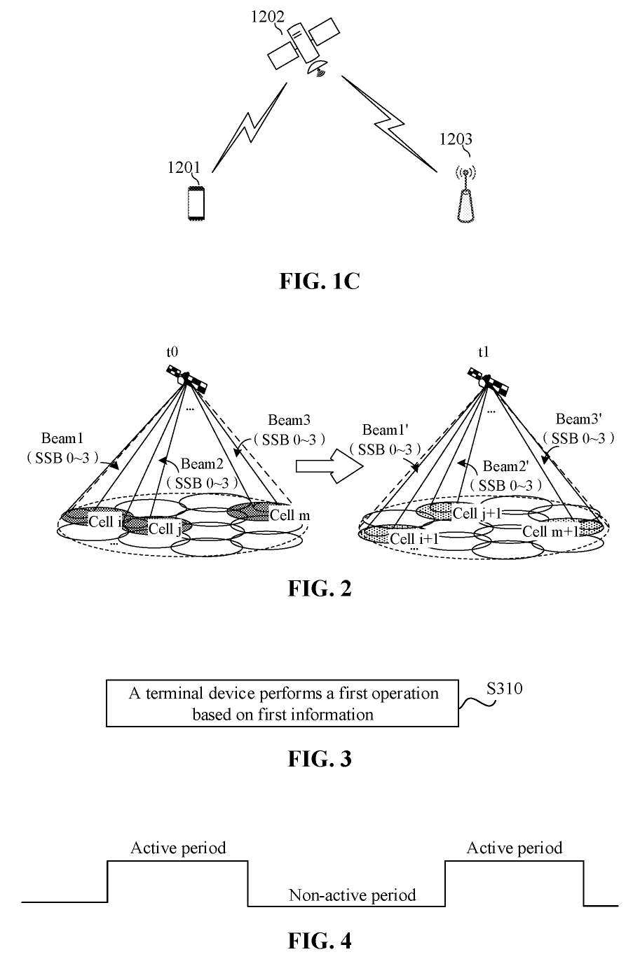

FIG. 1A is a schematic diagram of an architecture of a communication system according to an embodiment of the present disclosure. As shown in FIG. 1A, the communication system 100 may include a network device 110, which may be a device that communicates with a terminal device 120 (or referred to as a communication terminal, a terminal). The network device 110 may provide communication coverage for a particular geographic area and may communicate with terminal device(s) located within the coverage area.

FIG. 1A exemplarily illustrates one network device and two terminal devices. In some embodiments of the present disclosure, the communication system 100 may include a plurality of network devices, and the coverage range of each network device may include another number of terminal devices. The embodiments of the present disclosure are not limited thereto.

Exemplarily, FIG. 1B is a schematic diagram of another architecture of the communication system according to an embodiment of the present disclosure. Referring to FIG. 1B, there are a terminal device 1101 and a satellite 1102, and wireless communication may be performed between the terminal device 1101 and the satellite 1102. The network formed between the terminal device 1101 and the satellite 1102 may also be referred to as an NTN. In the architecture of the communication system illustrated in FIG. 1B, the satellite 1102 may have the functions of a base station, and the terminal device 1101 and the satellite 1102 may communicate directly. Under such system architecture, the satellite 1102 may be referred to as a network device. In some embodiments of the present disclosure, the communication system may include a plurality of network devices 1102, and the coverage range of each network device 1102 may include another number of terminal devices. The embodiments of the present disclosure are not limited thereto.

Exemplarily, FIG. 1C is a schematic diagram of another architecture of the communication system according to an embodiment of the present disclosure. Referring to FIG. 1C, there are a terminal device 1201, a satellite 1202, and a base station 1203, wireless communication may be performed between the terminal device 1201 and the satellite 1202, and communication may be performed between the satellite 1202 and the base station 1203. The network formed between the terminal device 1201, the satellite 1202, and the base station 1203 may also be referred to as an NTN. In the architecture of the communication system illustrated in FIG. 1C, the satellite 1202 may not have the functions of a base station, and communication between the terminal device 1201 and the base station 1203 requires relaying through the satellite 1202. Under such system architecture, the base station 1203 may be referred to as a network device. In some embodiments of the present disclosure, the communication system may include a plurality of network devices 1203, and the coverage range of each network device 1203 may include another number of terminal devices. The embodiments of the present disclosure are not limited thereto.

It should be noted that FIGS. 1A to 1C only illustrate the systems to which the present disclosure is applicable by way of example. Of course, the method shown in the embodiments of the present disclosure may also be applicable to other systems, such as a 5G communication system, an LTE communication system, and the like, which is not specifically limited in the embodiments of the present disclosure.

In some embodiments of the present disclosure, the wireless communication system shown in FIGS. 1A to 1C may further include other network entities such as a mobility management entity (MME), an access and mobility management function (AMF), and the like, which is not specifically limited in the embodiments of the present disclosure.

It should be understood that, in the embodiments of the present disclosure, the device having the communication function in the network/system may be referred to as the communication device. Taking the communication system 100 shown in FIG. 1A as an example, the communication device 100 may include the network device 110 and the terminal device 120 both having the communication function. The network device 110 and the terminal device 120 may be the specific devices described above, which are not described repeatedly herein. The communication device may further include other devices in the communication system 100, such as the network controller and the mobility management entity, which are not limited in the embodiments of the present disclosure.

It should also be understood that the term “indicate” referred to in the embodiments of the present disclosure may be a direct indication or an indirect indication, and may also be indicative of an associated relationship. For example, A indicates B, which may mean that A directly indicates B, e.g., B may be acquired through A. It may further mean that A indirectly indicates B, e.g., A indicates C, and B may be acquired through C. It may further mean that there is an association between A and B.

In the description of the embodiments of the present disclosure, the term “corresponding” may represent that there is a direct correspondence or an indirect correspondence between the two objects, or may further represent that there is an association relationship between the two objects, a relationship between the indication and the object to be indicated, or a relationship between the configuration and the object to be configured, or the like.

The “configuration” in the embodiments of the present disclosure may include configuration which is configured by at least one of the following: a system message, a radio resource control (RRC) signaling, and a media access control control element (MAC CE).

In some embodiments of the present disclosure, the “predefined” or “preset” may be realized by storing corresponding codes, tables, or other means capable of indicating relevant information in advance in devices (e.g., including terminal devices and network devices), and the present disclosure does not limit specific implementations thereof. For example, the “predefined” may refer to definition(s) specified in the protocol.

In some embodiments of the present disclosure, the “protocol” may refer to a standard protocol in the field of communication, and may include, for example, an LTE protocol, an NR protocol, and related protocols applicable to future communication systems, which are not limited in the present disclosure.

In the satellite communication, the satellites may have limited transmission power and processing bandwidth based on the deployment mode of the satellites as well as the signal to noise ratio (SNR) requirements of NTN systems for the physical channels of the terminal device. Therefore, the satellite may only be able to serve a portion of the area within the satellite coverage at the same time. In other words, due to the limited power and bandwidth of the feeder link, the satellite may not be able to enable all the beams to be in an active status at the same time while ensuring that each beam meets the nominal equivalent isotropic radiated power (EIRP) density. Accordingly, the related technologies propose employing beam hopping technology in the downlink.

FIG. 2 shows an example of a beam hopping implementation process. Referring to FIG. 2, at a time moment t0, a satellite serves a set of beams (i.e., beam 1, beam 2 and beam 3 shown in FIG. 2, each beam in the set of beams may be referred to as an active beam or an active satellite beam). The coverage range of each beam in the set of beams on the earth can be regarded as a cell. Thus, a plurality of active beams may correspondingly be in a plurality of active cells. Then, at a time moment t1, the set of beams become in a non-active status; and at this time, the satellite may activate another set of beams (i.e., beam 1’, beam 2’ and beam 3’ shown in FIG. 2). The above process refers to the beam hopping process in the multi-beam system. As can be seen from the above description, the beam hopping process may cause a cell to switch from an active status to a non-active status.

It should be understood that FIG. 2 illustrates only a satellite communication system as an example, and the embodiments of the present disclosure can be applied to any type of communication system supporting the beam hopping technology. For example, a plurality of beams or a plurality of sets of beams may be included within one cell. The plurality of beams or the plurality of sets of beams may be alternately in the active status or the non-active status. In such case, the cell may remain in the active status at all time, but some or all of the beams within the cell may be switched between the active status and the non-active status. The aforementioned process can also be understood as the beam hopping process.

The introduction of the beam hopping technology has an impact on the random access process of the terminal device, but the related technologies do not consider such impact, which may increase the probability of failure of the random access process. In view of the above problems, the embodiments of the present disclosure will be described in detail below.

FIG. 3 is a schematic flowchart of a method for wireless communication according to an embodiment of the present disclosure. The method of FIG. 3 may be applied to a wireless communication system that supports the beam hopping technology, such as an NTN system. The NTN system may be, for example, a satellite communication system. The method of FIG. 3 may be performed by the terminal device. The terminal device may be any of the types of terminal devices mentioned above. For example, the terminal device may be a terminal device that supports an NTN function or a satellite communication function.

Referring to FIG. 3, at block S310, the terminal device performs a first operation based on first information.

In some implementations, the first information is associated with an active period/non-active period of a first cell.

In some implementations, the first information is associated with an activation status/deactivation status of one or more beams (or beam directions) within the first cell.

In some implementations, the first operation is associated with random access of the first cell.

In some implementations, the first cell may be a cell in which the terminal device is currently located. Alternatively, the first cell may be a serving cell of the terminal device.

In some implementations, the first information may be used to indicate or determine a period or pattern of on/off of the first cell. As mentioned foregoing, in a beam hopping system, a beam transmitted by a network device (such as a satellite) may correspond to a cell. Taking the beam 1 corresponding to the cell 1 and the beam 2 corresponding to the cell 2 of the network device as an example, when the network device switches the active beam from the beam 1 to the beam 2, it is equivalent to the network device turning off the cell 1 and turning on the cell 2. From the perspective of the terminal device, if the terminal device is located within the coverage range of the cell 1 (i.e., the cell 1 is the serving cell of the terminal device), the terminal device may observe that the serving cell 1 transitions from the on state to the off state. After a period of time, the terminal device may observe that the serving cell 1 transitions from the off state to the on state again. The off period of the cell may also be referred to as the non-active period of the cell. The on period of the cell may also be referred to as the active period of the cell. FIG. 4 shows an example of a pattern of the active period/non-active period of the cell. From FIG. 4, it can be seen that the cell alternately enters the active period and the non-active period.

The non-active period of the cell mentioned in the embodiments of the present disclosure may be replaced by the non-active period of one or some beams in the cell, or the time interval between non-active statuses of one or some beams in the cell.

The active period of the cell mentioned in the embodiments of the present disclosure may be replaced by the active period of one or some beams in the cell, or the time interval between the active statuses of one or some beams in the cell.

It should be understood that the beam mentioned in the embodiments of the present disclosure may also be referred to as a space domain transmission filter. The beam may be associated with a resource index of a reference signal. The reference signal may be, for example, a downlink reference signal. For example, the beam may be associated with a channel state information reference signal (CSI-RS) resource index. As another example, the beam may be associated with a synchronization signal block (SSB) index.

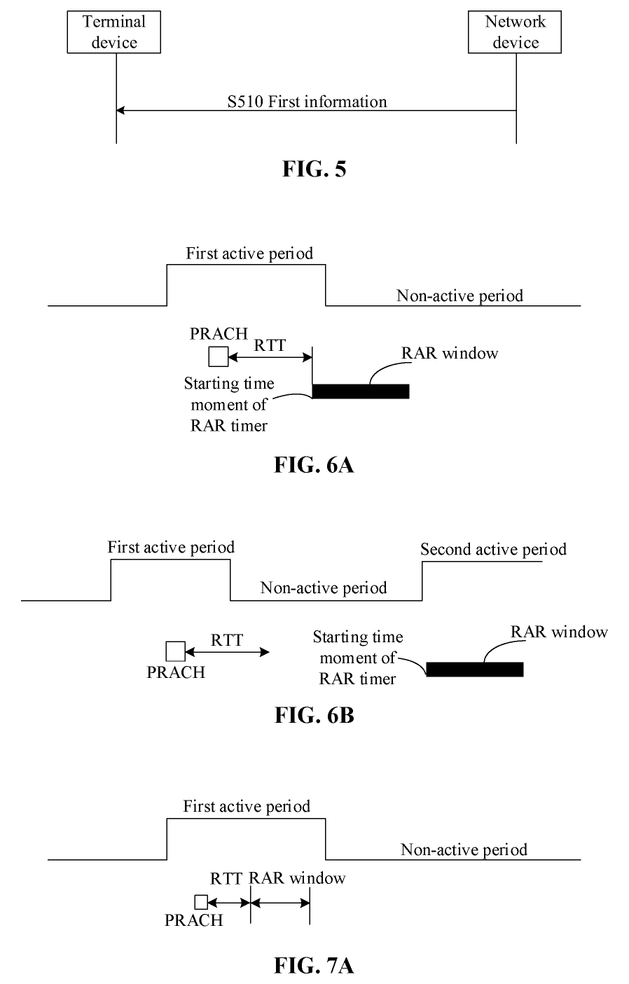

In some implementations, as shown in FIG. 5, the first information may be transmitted by the network device to the terminal device.

In some implementations, the first information may be carried in system information transmitted by the network device.

In some implementations, the first information may be used to indicate or determine one or more of the following: a duration of an active period of the terminal device, a remaining duration of the active period, a starting time moment of the active period, an ending time moment of the active period, a cycle of the active period, a starting time moment of a next active period of the current active period, and the like.

Embodiment 1: t he first operation includes initiating a first timer

The first timer mentioned in the embodiment 1 may be associated with a first message, and the first message may be a message for the random access transmitted by the terminal device.

In some implementations, the first message may be a message 1 (Msg1) for the random access, and the first timer associated with the first message may be a random access response (RAR) timer. For example, the first message may be a random access message. Alternatively, the first message may be used to transmit a physical random access channel (PRACH). In this implementation, the timing duration of the first timer may be referred to as a random access response window (RAR window).

In some implementations, the first message may be a message A (MsgA) for the random access, and the first timer associated with the first message may be a random access response timer. In this implementation, the timing duration of the first timer may be referred to as a random access response window.

In some implementations, the first message may be a message 3 (Msg3) for the random access, and the first timer associated with the first message may be a contention resolution timer. Alternatively, the first message may be used to transmit an Msg3 physical uplink shared channel (Msg3 PUSCH). In this implementation, the timing duration of the first timer may be referred to as a contention resolution window.

In some implementations, an initiating time of the first timer may be determined based on one or more of the following: a first time moment, a second time moment, a first time duration, and a second time duration. The first time moment is determined based on a transmission time of the first message. The second time moment is determined based on an ending time moment of a first active period of the first cell, and the first active period corresponds to the transmission time of the first message. The first time duration is determined based on a round trip time from the terminal device to the network device. In addition, the second time duration is determined based on a timing duration of the first timer.

In some implementations, the aforementioned operation S310 may be replaced by the terminal device determining the initiating time moment of the first timer based on one or more of the following: the first time moment, the second time moment, the first time duration, and the second time duration.

In some implementations, the first time moment may be determined based on a starting time moment or an ending time moment of the transmission time of the first message. For example, the first time moment may be the starting time moment or the ending time moment of the transmission time of the first message.

In some implementations, the first message may be a message 1 or message A, and the first message may be transmitted at a random access occasion or RACH occasion (RO). The first time moment may be determined based on the starting time moment or the ending time moment of the RO. For example, the first time moment may be the starting time moment or the ending time moment of the RO.

In some implementations, the second time moment being determined based on the ending time moment of the first active period of the first cell may include that the second time moment is the ending time moment of the first active period of the first cell. Alternatively, the second time moment being determined based on the ending time moment of the first active period of the first cell may include that the second time moment is equal to a sum of the ending time moment of the first active period and an offset value.

In some implementations, the first active period of the first cell corresponding to the transmission time of the first message may include that the transmission time of the first message falls in the first active period of the first cell. That is, the terminal device transmits the first message during the first active period of the first cell.

In some implementations, the first time duration being determined based on the round trip time (RTT) from the terminal device to the network device may include that the first time duration is equal to the round trip time from the terminal device to the network device. The round trip time may be determined based on a timing advance amount and/or T_{mac} of the terminal device. The T_{mac} may be configured by the network device. Alternatively, the first time duration being determined based on the round trip time from the terminal device to the network device may include that the first time duration is equal to a sum of the round trip time from the terminal device to the network device and an offset value.

In some implementations, the second time duration being determined based on the timing duration of the first timer may include that the second time duration is equal to the timing duration of the first timer. Alternatively, the second time duration being determined based on the timing duration of the first timer may include that the second time duration is equal to a sum of the timing duration of the first timer and an offset value.

In some implementations, if a third time moment is earlier than or equal to the second time moment, the first timer may be initiated at the third time moment; and/or, if the third time moment is later than the second time moment, the first timer may be initiated in a second active period (e.g., at the starting time moment of the second active period). The third time moment is a time moment corresponding to a sum of the first time moment and the first time duration. In other words, the third time moment is a time moment acquired by shifting the first time moment forward by the first time duration.

FIGS. 6A and 6B illustrate an example of a determination manner for the initiating time moment of the RAR timer (corresponding to the first timer above). Referring to FIGS. 6A and 6B, the terminal device selects an RO for transmitting a PRACH during the first active period of the cell. The terminal device then transmits the PRACH at the RO (the transmission of the PRACH corresponds to the transmission of the first message described above). Upon the completion of the PRACH transmission, the ending time moment of the PRACH transmission may be set to t0 (corresponding to the first time moment described above). Then, the terminal device may set a time duration T (corresponding to the first time duration described above) on the basis of t0, and the time duration T may be an RTT from the terminal device to the network device in the NTN system. Subsequently, the terminal device may determine the relationship between t0+T (corresponding to the third time moment described above) and the ending time moment of the first active period (corresponding to the second time moment described above). For example, as shown in FIG. 6A, if t0+T occurs before the ending time moment of the first active period, the terminal device initiates the RAR timer. For another example, as shown in FIG. 6B, if t0+T occurs after the ending time moment of the first active period (i.e., t0+T is in the non-active period of the cell), the terminal device may initiate the RAR timer in the second active period (i.e., the next active period of the first active period).

In some implementations, if a fourth time moment is earlier than or equal to the second time moment, the first timer may be initiated at a third time moment; and/or, if the fourth time moment is later than the second time moment, the first timer may be initiated at a starting time moment of a second active period. Herein, the third time moment is a time moment corresponding to a sum of the first time moment and the first time duration (or the third time moment is the time moment acquired by shifting the first time moment forward by the first time duration). The fourth time moment is a time moment corresponding to a sum of the first time moment, the first time duration and the second time duration (or the fourth time moment is the time moment acquired by shifting the first time moment forward by the first time duration and the second time duration), and the second active period is a next active period of the first active period.

FIGS. 7A and 7B illustrate an example of a determination manner for the initiating time moment of the RAR timer (corresponding to the first timer above). Referring to FIGS. 7A and 7B, the terminal device selects an RO for transmitting a PRACH during the first active period of the cell. The terminal device then transmits the PRACH at the RO (the transmission of the PRACH corresponds to the transmission of the first message described above). Upon the completion of the PRACH transmission, the ending time moment of the PRACH transmission may be set to t0 (corresponding to the first time moment described above). Then, the terminal device may set T1 (corresponding to the first time duration described above) and T2 (corresponding to the second time duration described above) on the basis of t0, T1 may be equal to the RTT from the terminal device to the network device in the NTN system, and T2 may be equal to the timing duration of the RAR timer (i.e., the time duration corresponding to the RAR window). Subsequently, the terminal device may determine the relationship between t0+T1+T2 (corresponding to the fourth time moment described above) and the ending time moment (corresponding to the second time moment described above) of the first active period. For example, as shown in FIG. 7A, if t0+T1+T2 occurs before the ending time moment of the first active period, the terminal device initiates the RAR timer at t0+T1 (corresponding to the third time moment described above). For another example, as shown in FIG. 7B, if t0+T1+T2 occurs after the ending time moment of the first active period (i.e., t0+T1+T2 is in the non-active period of the cell), the terminal device may initiate the RAR timer in the second active period (i.e., the next active period of the first active period).

In some implementations, the operation S310 may include or be replaced by that: if the terminal device transmits a first message during a first non-active period of the first cell, the terminal device may initiate the first timer at a starting time moment of a next active period of the first non-active period. Herein, the first message is a message for random access, and the first timer is associated with the first message.

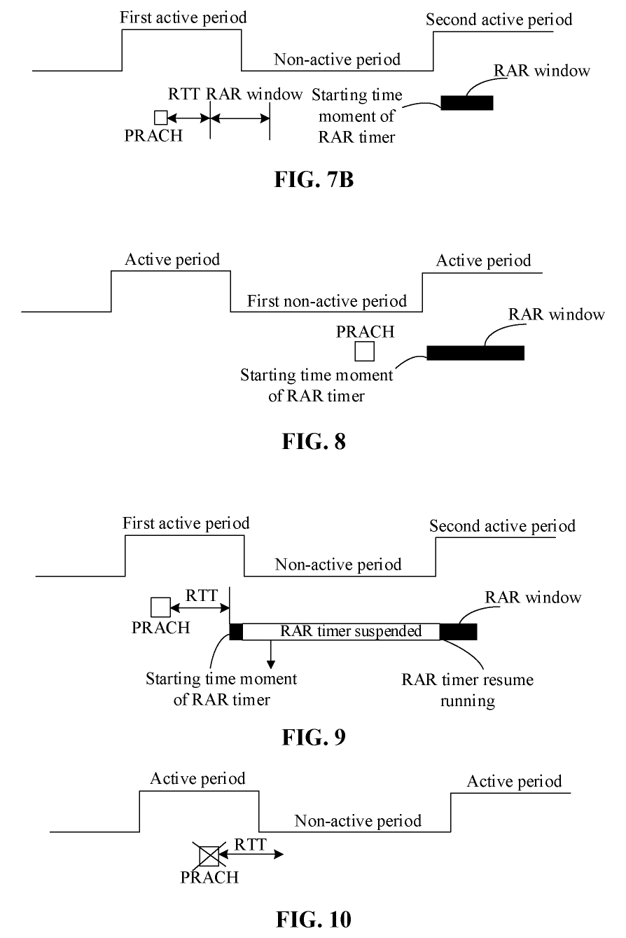

FIG. 8 illustrates an example of a determination manner for the initiating time moment of the first timer. Referring to FIG. 8, the terminal device transmits a PRACH (corresponding to the transmission of the first message described above) during the first non-active period of the cell. In such case, the terminal device may initiate the RAR timer (corresponding to the first timer described above) at a next active period of the first non-active period.

Embodiment 2: t he first operation includes suspending the first timer

In the second embodiment, the operation S310 may include or be replaced by that: if a first timer runs to a first non-active period of the first cell, the terminal device suspends the first timer. Herein, the first timer is associated with a first message, and the first message is a message for the random access transmitted by the terminal device.

Further, in some implementations, the terminal device may resume running the first timer at the starting time moment of the next active period of the first non-active period.

Referring to FIG. 9, the terminal device selects an RO for transmitting a PRACH during the first active period of the cell. The terminal device then transmits the PRACH at the RO (the transmission of the PRACH corresponds to the transmission of the first message described above). Upon the completion of the PRACH transmission, the ending time moment of the PRACH transmission may be set to t0 (corresponding to the first time moment described above). Then, the terminal device may set T on the basis of t0, and T may be equal to the RTT from the terminal device to the network device in the NTN system. Subsequently, the terminal device may initiate the RAR timer (corresponding to the first timer described above) after t0+T. If the RAR timer runs to a non-active period of the cell, the RAR timer may be suspended at this time. When the starting time moment of the next active period of the cell arrives, the terminal device may resume running the RAR timer.

Embodiment 3: t he first operation includes determining whether a first random access occasion within a first active period of the first cell is valid

In some implementations, whether the first random access occasion is valid may be determined based on one or more of the following: a first time moment, a second time moment, a first time duration, and a second time duration. The first time moment is determined based on a time corresponding to the first random access occasion (or first RO). The second time moment is determined based on an ending time moment of the first active period. The first time duration is determined based on a round trip time from the terminal device to a network device. The second time duration is determined based on a timing duration of a first timer, and the first timer is associated with a message that is transmitted by using the first random access occasion.

In some implementations, the aforementioned operation S310 may be replaced by the terminal device determining whether the first random access occasion within the first active period of the first cell is valid based on one or more of the following: the first time moment, the second time moment, the first time duration, and the second time duration.

In some implementations, the first time moment may be determined based on a starting time moment or an ending time moment of the first random access occasion. For example, the first time moment may be the starting time moment or the ending time moment of the first random access occasion. Alternatively, the first time moment may be a time moment corresponding to a sum of an offset value and the starting time moment or the ending time moment of the first random access occasion.

In some implementations, the second time moment being determined based on the ending time moment of the first active period of the first cell may include that the second time is the ending time moment of the first active period of the first cell. Alternatively, the second time moment being determined based on the ending time moment of the first active period of the first cell may include that the second time moment is equal to a sum of an offset value and the ending time moment of the first active period.

In some implementations, the first time duration being determined based on the round trip time from the terminal device to the network device may include that the first time duration is equal to the round trip time from the terminal device to the network device. The round trip time may be determined based on a timing advance amount and/or T_{mac} of the terminal device. The T_{mac} may be configured by the network device. Alternatively, the first time duration being determined based on the round trip time from the terminal device to the network device may include that the first time duration is equal to a sum of the round trip time from the terminal device to the network device and the offset value.

In some implementations, the second time duration being determined based on the timing duration of the first timer may include that the second time duration is equal to the timing duration of the first timer. Alternatively, the second time duration being determined based on the timing duration of the first timer may include that the second time duration is equal to a sum of the timing duration of the first timer and an offset value. The first timer mentioned herein may be associated with the message transmitted at the first random access occasion. For example, when the first random access occasion is used to transmit a random access message (or PRACH), the first timer may be a RAR timer associated with the random access message.

In some implementations, if a third time moment is earlier than or equal to the second time moment, the first random access occasion may be valid; and/or, if the third time moment is later than the second time moment, the first random access occasion may be invalid. Herein, the third time moment is a time moment corresponding to a sum of the first time moment and the first time duration. In other words, the third time moment is a time moment acquired by shifting the first time moment forward by the first time duration.

Referring to FIG. 10, the terminal device determines, based on configuration information from the network device, that an RO (corresponding to the first random access occasion described above) exists in the first active period of the first cell. The terminal device may determine the ending time moment of the RO as t0 (corresponding to the first time moment described above). Then, the terminal device may determine the relationship between t0+T (corresponding to the third time moment described above, T may represent the RTT) and the ending time moment (corresponding to the second time moment described above) of the first active period. If t0+T exceeds the ending time moment of the first active period, the terminal device determines that the RO is an invalid RO. If t0+T does not exceed the ending time moment of the first active period, the terminal device determines that the RO is a valid RO.

In some implementations, if a fourth time moment is earlier than or equal to the second time moment, the first random access occasion may be valid; and/or, if the fourth time moment is later than the second time moment, the first random access occasion may be invalid. Herein, the fourth time moment is a time moment corresponding to a sum of the first time moment, the first time duration and the second time duration. In other words, the fourth time moment is the time moment acquired by shifting the first time moment forward by the first time duration and the second time duration.

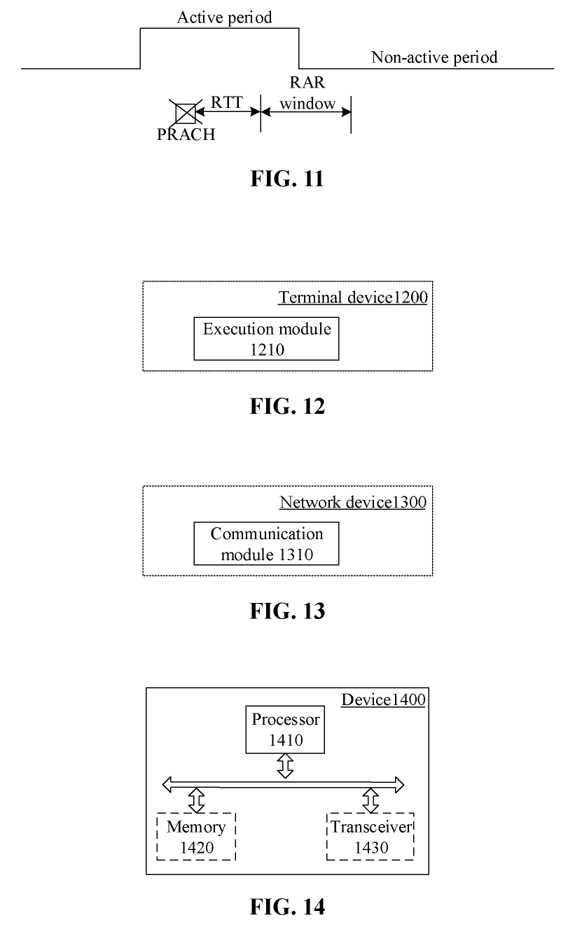

Referring to FIG. 11, the terminal device determines, based on configuration information from the network device, that an RO (corresponding to the first random access occasion described above) exists in the first active period of the first cell. The terminal device may determine the ending time moment of the RO as t0 (corresponding to the first time moment described above). Then, the terminal device may determine the relationship between t0+T1+T2 (corresponding to the fourth time moment described above, where T1 represents the RTT, T1 corresponds to the first time duration described above; T2 represents the timing duration of the RAR timer, that is, the time duration corresponding to the random access response window, and T2 corresponds to the second time duration described above) and the ending time moment (corresponding to the second time moment described above) of the first active period. If t0+T1+T2 exceeds the ending time moment of the first active period, the terminal device determines that the RO is an invalid RO. If t0+T1+T2 does not exceed the ending time moment of the first active period, the terminal device determines that the RO is a valid RO.

In some implementations, if the first random access occasion is valid, the terminal device may transmit the random access message through the first random access occasion.

In some implementations, if the first random access occasion is invalid, the terminal device does not transmit the random access message through the first random access occasion.

The method embodiments of the present disclosure are described in detail above with reference to FIGS. 1 to 11, and the device embodiments of the present disclosure are described in detail below with reference to FIGS. 12 to 14. It should be understood that the description of the method embodiments and the description of the device embodiments correspond to each other; and therefore, the portions not described in detail may be referred to the foregoing method embodiments.

FIG. 12 is a schematic structural diagram of a terminal device according to an embodiment of the present disclosure. The terminal device 1200 of FIG. 12 may perform the method performed by the terminal device in any of the above embodiments. The terminal device 1200 includes an execution module 1210. The execution module 1210 is configured to perform a first operation based on first information. Herein, the first operation is associated with random access of a first cell; and the first information has one or more of the following associations: an association with an active period/non-active period of the first cell; and, an association with an activation status/deactivation status of one or more beams within the first cell.

In some implementations, the first operation may include initiating a first timer; where the first timer is associated with a first message, and the first message is a message for the random access transmitted by the terminal device.

In some implementations, an initiating time of the first timer is determined based on one or more of the following: a first time moment, a second time moment, a first time duration and a second time duration. The first time moment is determined based on a transmission time of the first message. The second time moment is determined based on an ending time moment of a first active period of the first cell, and the first active period corresponds to the transmission time of the first message. The first time duration is determined based on a round trip time from the terminal device to a network device. The second time duration is determined based on a timing duration of the first timer.

In some implementations, if a third time moment is earlier than or equal to the second time moment, the first timer may be initiated at the third time moment; and/or, if the third time moment is later than the second time moment, the first timer may be initiated at a starting time moment of a second active period. Herein, the third time moment is a time moment corresponding to a sum of the first time moment and the first time duration, and the second active period is a next active period of the first active period.

In some implementations, if a fourth time moment is earlier than or equal to the second time moment, the first timer may be initiated at a third time moment; and/or, if the fourth time moment is later than the second time moment, the first timer may be initiated at a starting time moment of a second active period. Herein, the third time moment is a time moment corresponding to a sum of the first time moment and the first time duration; the fourth time moment is a time moment corresponding to a sum of the first time moment, the first time duration and the second time duration; and the second active period is a next active period of the first active period.

In some implementations, the execution module 1210 may be configured to suspend a first timer, if the first timer runs to a first non-active period of the first cell. Herein, the first timer is associated with a first message, and the first message is a message for the random access transmitted by the terminal device.

In some implementations, the execution module 1210 may be configured to initiate a first timer at a starting time moment of a next active period of the first non-active period, if the terminal device transmits a first message during a first non-active period of the first cell. Herein, the first message is a message for the random access, and the first timer is associated with the first message.

In some implementations, the first message may be a message 1 or a message A for the random access, and the first timer associated with the first message may be a random access response timer. Alternatively, the first message may be a message 3 for the random access, and the first timer associated with the first message may be a contention resolution timer.

In some implementations, the first operation may include determining whether a first random access occasion within a first active period of the first cell is valid.

In some implementations, whether the first random access occasion is valid may be determined based on one or more of the following: a first time moment, a second time moment, a first time duration and a second time duration. The first time moment is determined based on a time corresponding to the first random access occasion. The second time moment is determined based on an ending time moment of the first active period. The first time duration is determined based on a round trip time from the terminal device to a network device. The second time duration is determined based on a timing duration of a first timer, and the first timer is associated with a message that is transmitted by using the first random access occasion.

In some implementations, if a third time moment is earlier than or equal to the second time moment, the first random access occasion may be valid; and/or, if the third time moment is later than the second time moment, the first random access occasion may be invalid. Herein, the third time moment is a time moment corresponding to a sum of the first time moment and the first time duration.

In some implementations, if a fourth time moment is earlier than or equal to the second time moment, the first random access occasion may be valid; and/or, if the fourth time moment is later than the second time moment, the first random access occasion may be invalid. Herein, the fourth time moment is a time moment corresponding to a sum of the first time moment, the first time duration and the second time duration.

In some implementations, the first information may be carried in system information transmitted by a network device.

FIG. 13 is a schematic structural diagram of a network device according to an embodiment of the present disclosure. The network device 1300 in FIG. 13 may perform the method performed by the network device in any of the preceding embodiments. The network device 1300 includes a communication module 1310. The communication module 1310 is configured to transmit first information. Herein, the first information has one or more of the following associations: an association with an active period/non-active period of a first cell; and an association with an activation status/deactivation status of one or more beams within the first cell.

In some implementations, the first information may be carried in system information.

FIG. 14 is a schematic structural diagram of a device according to an embodiment of the present disclosure. The dashed lines in FIG. 14 indicate that the unit or module is optional. The device 1400 may be used to implement the methods described in the method embodiments described above. The device 1400 may be a chip, a terminal device, or a network device.

The device 1400 may include one or more processors 1410. The processor 1410 may enable the device 1400 to implement each of the methods described in the preceding method embodiments. The processor 1410 may be a general-purpose processor or a special-purpose processor. For example, the processor may be a central processing unit (CPU). Alternatively, the processor may also be another general purpose processor, a digital signal processor (DSP), an application specific integrated circuit (ASIC), a field programmable gate array (FPGA) or other programmable logic device, a discrete gate or transistor logic device, a discrete hardware component, or the like. The general-purpose processor may be a microprocessor or the processor may be any conventional processor or the like.

The device 1400 may also include one or more memories 1420. The memory 1420 stores a program which is executable by the processor 1410, enabling the device 1400 to perform each of the methods described in the above method embodiments. The memory 1420 may be independent of the processor 1410 or may be integrated in the processor 1410.

The device 1400 may also include a transceiver 1430. The processor 1410 may communicate with other devices or chips through the transceiver 1430. For example, the processor 1410 may transmit and receive data with other devices or chips through the transceiver 1430.

The embodiments of the present disclosure also provide a computer-readable storage medium, and the computer-readable storage medium is configured to store a program. The computer-readable storage medium may be applied to the terminal device or the network device provided by the embodiments of the present disclosure, and the program enables a computer to perform each of the methods performed by the terminal device or the network device in each embodiment of the present disclosure.

The embodiments of the present disclosure also provide a computer program product. The computer program product includes a program. The computer program product may be applied to the terminal device or the network device provided by the embodiments of the present disclosure, and the program enables a computer to perform each of the methods performed by the terminal device or the network device in each embodiment of the present disclosure.

The embodiments of the present disclosure also provide a computer program. The computer program may be applied to the terminal device or the network device provided by the embodiments of the present disclosure, and the computer program enables a computer to perform each of the methods performed by the terminal device or the network device in each embodiment of the present disclosure.

It should be understood that, in the embodiments of the present disclosure, “B corresponding to A” means that B is associated with A, and B can be determined based on A. However, it should also be understood that determining B based on A does not mean that B is determined based on A alone, and that B may also be determined based on A and/or other information.

It should be understood that the term “and/or” herein only indicates an association relationship for describing associated objects and represents that there are three relationships. For example, A and/or B may represent three cases: i.e., independent existence of A, existence of both A and B and independent existence of B. In addition, the character “/” in the present disclosure typically represents that previous and next associated objects form an “or” relationship.

It should be understood that, in various embodiments of the present disclosure, the size of the sequence number(s) of the above-mentioned processes do not imply the sequence(s) of execution. The sequence of execution of each process should be determined according to the functions and internal logic thereof, and should not constitute any limitation on the implementation processes of the embodiments of the present disclosure.

In several embodiments provided herein, it should be understood that the disclosed systems, apparatuses, and methods may be implemented in other manners. For example, the device embodiments described above are merely illustrative. For example, the division of units is only logical functional division, and other division manners may be adopted during practical implementation, e.g., multiple units or components may be combined or integrated into another system, or some features may be ignored or not implemented. In addition, the displayed or discussed mutual couplings or direct couplings or communication connections may be implemented by using some interfaces. The indirect couplings or communication connections between the devices or units may be implemented in electronic, mechanical, or other forms.

The units described as separate components may or may not be physically separated, and the components displayed as units may or may not be physical units, that is, may be located in one place or may be distributed over multiple network units. Some or all of the units may be selected according to actual needs, to achieve the objectives of the schemes of the embodiments of the present disclosure.

In addition, functional units in various embodiments of the present disclosure may be integrated into one processing unit, or each of the units may be physically separated, or two or more units may be integrated into one unit.

In aforementioned embodiments may be implemented in whole or in part by software, hardware, firmware or any combination thereof. When implemented in software, the aforementioned embodiments may be implemented in whole or in part in the form of a computer program product. The computer program product includes one or more computer instructions. When the computer program instructions are loaded and executed on a computer, the flows or functions may be generated in whole or in part according to the embodiments of the present disclosure. The computer may be a general purpose computer, a dedicated computer, a computer network, or other programmable devices. The computer instructions may be stored in a computer-readable storage medium or transmitted from one computer-readable storage medium to another computer-readable storage medium. For example, the computer instructions may be transmitted from one Web site, computer, server, or data center to another Web site, computer, server, or data center in a wired (e.g., coaxial cable, optical fiber, digital subscriber line (DSL)) manner or a wireless (e.g., infrared, wireless, microwave, etc.) manner. The computer-readable storage medium may be any available medium that a computer may access, or may be a data storage device that is integrated with one or more available media, such as a server, a data center, or the like. The available medium may be a magnetic medium (e.g., floppy disk, hard disk, magnetic tape), an optical medium (e.g., digital video disc (DVD)), or a semiconductor medium (e.g., solid state disk (SSD)), etc.

The foregoing descriptions are merely specific implementations of the present disclosure, but are not intended to limit the scope of protection of the present disclosure. Any variation or replacement readily figured out by those skilled in the art within the technical scope disclosed in the present disclosure shall fall within the scope of protection of the present disclosure. Therefore, the scope of protection of the present disclosure shall be subject to the scope of protection of the claims.

1. A method for wireless communication, comprising:
performing, by a terminal device, a first operation based on first information;
wherein the first operation is associated with random access of a first cell;
wherein the first information has one or more of the following associations:
an association with an active period/non-active period of the first cell; and
an association with an activation status/deactivation status of one or more beams within the first cell.

2. The method of claim 1, wherein the first operation comprises initiating a first timer; the first timer is associated with a first message, and the first message is a message for the random access transmitted by the terminal device.

3. The method of claim 2, wherein an initiating time of the first timer is determined based on one or more of the following:
a first time moment, the first time moment being determined based on a transmission time of the first message;
a second time moment, the second time moment being determined based on an ending time moment of a first active period of the first cell, and the first active period corresponding to the transmission time of the first message;
a first time duration, the first time duration being determined based on a round trip time from the terminal device to a network device; and
a second time duration, the second time duration being determined based on a timing duration of the first timer.

4. The method of claim 3, wherein
if a third time moment is earlier than or equal to the second time moment, the first timer is initiated at the third time moment; and/or
if the third time moment is later than the second time moment, the first timer is initiated at a starting time moment of a second active period;
wherein the third time moment is a time moment corresponding to a sum of the first time moment and the first time duration; and the second active period is a next active period of the first active period.

5. The method of claim 3, wherein
if a fourth time moment is earlier than or equal to the second time moment, the first timer is initiated at a third time moment; and/or
if the fourth time moment is later than the second time moment, the first timer is initiated at a starting time moment of a second active period;
wherein the third time moment is a time moment corresponding to a sum of the first time moment and the first time duration; the fourth time moment is a time moment corresponding to a sum of the first time moment, the first time duration and the second time duration; and the second active period is a next active period of the first active period.

6. The method of claim 1, wherein performing, by the terminal device, the first operation based on the first information comprises:
if a first timer runs to a first non-active period of the first cell, suspending, by the terminal device, the first timer;
wherein the first timer is associated with a first message, and the first message is a message for the random access transmitted by the terminal device.

7. The method of claim 1, wherein performing, by the terminal device, the first operation based on the first information comprises:
if the terminal device transmits a first message during a first non-active period of the first cell, initiating, by the terminal device, a first timer at a starting time moment of a next active period of the first non-active period;
wherein the first message is a message for the random access, and the first timer is associated with the first message.

8. The method of claim 2, wherein
the first message is a message 1 or a message A for the random access, and the first timer associated with the first message is a random access response timer; or,
the first message is a message 3 for the random access, and the first timer associated with the first message is a contention resolution timer.

9. The method of claim 1, wherein the first operation comprises determining whether a first random access occasion within a first active period of the first cell is valid.

10. The method of claim 9, wherein whether the first random access occasion is valid is determined based on one or more of the following:
a first time moment, the first time moment being determined based on a time corresponding to the first random access occasion;
a second time moment, the second time moment being determined based on an ending time moment of the first active period;
a first time duration, the first time duration being determined based on a round trip time from the terminal device to a network device; and
a second time duration, the second time duration being determined based on a timing duration of a first timer;
wherein the first timer is associated with a message that is transmitted by using the first random access occasion.

11. The method of claim 10, wherein
if a third time moment is earlier than or equal to the second time moment, the first random access occasion is valid; and/or
if the third time moment is later than the second time moment, the first random access occasion is invalid;
wherein the third time moment is a time moment corresponding to a sum of the first time moment and the first time duration.

12. The method of claim 10, wherein
if a fourth time moment is earlier than or equal to the second time moment, the first random access occasion is valid; and/or
if the fourth time moment is later than the second time moment, the first random access occasion is invalid;
wherein the fourth time moment is a time moment corresponding to a sum of the first time moment, the first time duration and the second time duration.

13. The method of claim 1, wherein the first information is carried in system information transmitted by a network device.

14. A terminal device, comprising:
a memory, configured to store a program; and
a processor;
wherein the processor is configured to call and run the program in the memory to: perform a first operation based on first information;
wherein the first operation is associated with random access of a first cell;
wherein the first information has one or more of the following associations:
an association with an active period/non-active period of the first cell; and
an association with an activation status/deactivation status of one or more beams within the first cell.

15. The terminal device of claim 14, wherein the first operation comprises initiating a first timer; the first timer is associated with a first message, and the first message is a message for the random access transmitted by the terminal device.

16. The terminal device of claim 14, wherein the processor is further configured to call and run the program in the memory to:
if a first timer runs to a first non-active period of the first cell, suspend the first timer;
wherein the first timer is associated with a first message, and the first message is a message for the random access transmitted by the terminal device.

17. The terminal device of claim 14, wherein the processor is further configured to call and run the program in the memory to:
if the terminal device transmits a first message during a first non-active period of the first cell, initiate a first timer at a starting time moment of a next active period of the first non-active period;
wherein the first message is a message for the random access, and the first timer is associated with the first message.

18. The terminal device of claim 14, wherein the first operation comprises determining whether a first random access occasion within a first active period of the first cell is valid.

19. A network device, comprising:
a memory, configured to store a program;
a processor; and
a transceiver;
wherein the processor is configured to call and run the program in the memory and control the transceiver to: transmit first information;
wherein the first information has one or more of the following associations:
an association with an active period/non-active period of a first cell; and
an association with an activation status/deactivation status of one or more beams within the first cell.

20. The network device of claim 19, wherein the first information is carried in system information.
